(19) United States
(12) Patent Application Publication
(10) Pub. No.: US 2023/0000072 A1
(43) Pub. Date: Jan. 5, 2023

(54) ORGANIC BASED EMULSIONS FOR SUN FILTER APPLICATIONS

(71) Applicant: OMYA INTERNATIONAL AG, Oftringen (CH)

(72) Inventors: Jamal FTOUNI, Zofingen (CH); Fabrizio ORLANDO, Würenlos (CH)

(73) Assignee: OMYA INTERNATIONAL AG, Oftringen (CH)

(21) Appl. No.: 17/756,677

(22) PCT Filed: Dec. 7, 2020
(86) PCT No.: PCT/EP2020/084874

§ 371 Date: May 31, 2022

(30) Foreign Application Priority Data
Dec. 10, 2019 (EP) 19214765.0

(51) Int. Cl. A01N 3/00

(52) U.S. Cl. CPC A01N 3/00

(57) ABSTRACT

The present invention refers to an agricultural composition for providing UV-A and/or UV-B protection to plants and parts thereof, the composition comprising at least one wax, at least one lignin, at least one emulsifier, water, optionally calcium carbonate, and optionally a solvent, wherein the ratio of wax:lignin in the composition is from 100:1 to 100:200 based on the dry weight of the wax and the lignin. Furthermore, the present invention refers to the use of such an agricultural composition for UV-A and/or UV-B protection of plants and parts thereof as well as to the use of the combination of at least one wax and at least one lignin as UV-A and/or UV-B protecting agent, wherein the ratio of wax:lignin is from 100:1 to 100:200 based on the dry weight of the wax and the lignin.

The present invention refers to an agricultural composition for providing UV-A and/or UV-B protection to plants and parts thereof, the composition comprising at least one wax, at least one lignin, at least one emulsifier, water, optionally calcium carbonate, and optionally a solvent, wherein the ratio of wax:lignin in the composition is from 100:1 to 100:200 based on the dry weight of the wax and the lignin. Furthermore, the present invention refers to the use of such an agricultural composition for UV-A and/or UV-B protection of plants and parts thereof as well as to the use of the combination of at least one wax and at least one lignin as UV-A and/or UV-B protecting agent, wherein the ratio of wax:lignin is from 100:1 to 100:200 based on the dry weight of the wax and the lignin.

It is well known that the sunlight energy and mainly the ultraviolet portion of the sun's spectrum has a damaging effect on plants and parts thereof. In particular, the ultraviolet B (UV-B) radiation which ranges from 280 to 320 nm and the ultraviolet A (UV-A) radiation which ranges from >320 to 400 nm both cause sunburn to plants and parts thereof. Especially, when the shaded air temperature is above a temperature of ca. 30° C., plants and parts thereof and especially fruits can be damaged due to sunburn. The consequence of such a “fruit sunburn” is a damage of the fruits and a decrease of the total production yield, causing an economic impact, mainly in hot summer seasons.

Therefore, it is becoming increasingly important to protect at least the part of the plants and parts thereof and especially, the fruits which are exposed to sun light against UV-B as well as UV-A radiation. In the art several attempts have been made to provide such UV protection.

For example, CN 203 538 002 refers to a pomegranate cultivation bag capable of preventing sunburn, wherein one side of the pomegranate cultivation bag is reflective, and the other side is transparent. During a high temperature season, the pomegranate cultivation bag is sleeved over a pomegranate with the reflective side facing the sun to reflect most of sun light in the noon to prevent sunburn of the pomegranate, and partial sun light reflected by a reflective plastic film irradiates on the leaves at the shady side of a fruit tree to increase the photosynthesis of the entire orchard. However, such a procedure is complex, time-consuming and labor-intensive, since every plant or fruit has to be treated individually by hand.

Another option to reduce the probability of sunburn is the using of mineral particles, usually clay or calcium carbonate, which form a film on the plants and parts thereof that reflect/block the damaging UV radiation. Such sunscreen compositions for applications to plants are known, for example from US 2012/0052187 A1 that refers to a sunscreen composition comprising Titanium Dioxide (TiO2), Zinc Oxide (ZnO), Silicon Dioxide (SiO2), a surfactant, wetting agent, dispersant (SWD) and water. The composition forms a suspension concentrate when combined that when diluted in water provides a solution that provides uniform coverage using convention spraying equipment.

WO 2010/008476 A1 refers to a method for increasing a yield of a crop including controlling plant tissue stress by at least partially coating a plant tissue with a composition comprising an agricultural sunscreen formulation and a second agricultural chemical. The agricultural sunscreen formulation may comprise 40 to 80 wt.-% calcium carbonate, 1 to 5 wt.-% bicarbonate and 15 to 59 wt.-% water.

However, the main disadvantage of such particle films is the “white-washed” appearance of the treated plants and fruits. Such a white to greyish film on plants and fruits looks unappetizing and is rejected by consumers.

A potential alternative to such “white-washed” films are wax-based products, such as carnauba wax, which appear essentially transparent after the application. Such wax-based sunscreens are, for example, known from U.S. Pat. No. 7,222,455 B2 that refers to methods and compositions for suppressing cracking, stem browning, and water loss in fruit or vegetables, such as cherries. The methods comprise applying to fruits or vegetables an amount of a wax emulsion comprising from about 0.125% to about 25% (weight/weight) of carnauba wax, from about 0.1% to about 16% (weight/weight) of oleic acid, and from about 0.03% to about 6% (weight/weight) of morpholine, and from about 53% to about 99.7% (weight/weight) of water.

U.S. Pat. No. 4,946,694 B2 refers to a system for coating sticky fruit, which system comprises a first composition including a vegetable wax, a vegetable oil and a wetting agent and a second composition including a protein, said first composition being applied to said fruit before said second composition, said first and second compositions being applied in an amount sufficient to give fruit that is no longer sticky. The vegetable wax could be, for example, carnauba wax.

In such compositions the vegetable wax such as the carnauba wax is usually the main active ingredient against the sun damage. However, some waxes filter out a significant fraction of UV-B but are less efficient against UV-A radiation.

Therefore, there is a continuous need in the art for adequate formulations or compositions providing sufficient or improved UV-B and/or UV-A protection to plants and parts thereof.

Thus, it is an objective of the present invention to provide an agricultural composition for providing sufficient or improved UV-B and/or UV-A protection to plants and parts thereof, especially to fruits. In particular, it is an objective of the present invention to provide an agricultural composition that is translucent or at least provides only a pale film or shimmer on the plants and parts thereof that are treated with such a composition. A further object of the present invention is that the compounds used in these agricultural compositions are non-toxic to humans, do not provide a harmful effect on the environment and preferably are approved by the food act to be used on plants and parts thereof, especially on fruits. Another object of the present invention is that the compositions should be easily and quickly produced, cheap and especially easy to handle. It is especially preferred that the compositions are sprayable and that they stick to the plants and parts thereof and don't get washed off easily by rain.

These and other objectives of the present invention can be solved by an agricultural composition for providing UV-A and/or UV-B protection to plants and parts thereof as described in the present invention and defined in the claims. Advantageous embodiments of the invention are defined in the corresponding sub-claims.

According to one embodiment of the present invention an agricultural composition for providing UV-A and/or UV-B protection to plants and parts thereof is provided the composition comprising at least one wax, at least one lignin, at least one emulsifier, water, optionally calcium carbonate, and optionally a solvent; wherein the ratio of wax:lignin in the composition is from 100:1 to 100:200 based on the dry weight of the wax and the lignin.

The inventors surprisingly found out that the foregoing agricultural composition provides sufficient or improved UV-B and/or UV-A protection to plants and parts thereof, especially to fruits. Especially, the inventors surprisingly found that when at least one wax is used in combination with at least one lignin, wherein the ratio of wax:lignin in the composition is from 100:1 to 100:200 based on the dry weight of the wax and the lignin, the agricultural composition provides improved UV-B and/or UV-A protection to plants and parts thereof. Furthermore, the agricultural composition of the present invention is translucent or at least provides only a pale film or shimmer on the plants and parts thereof that are treated with such a composition. The compounds used in these agricultural compositions are non-toxic to humans, generally speaking do not provide a harmful effect on the environment and preferably are approved by the food act to be used on plants and parts thereof, especially on fruits. Furthermore, the inventors surprisingly found that the compositions of the present invention can be easily and quickly produced, are cheap and especially easy to handle. Due to the consistency of the agricultural compositions of the present invention, the compositions are sprayable and they stick to the plants and parts thereof and don't get washed off easily by rain.

According to another aspect of the present invention the inventive agricultural composition is used for UV-A and/or UV-B protection of plants and parts thereof.

According to another aspect of the present invention the combination of at least one wax and at least one lignin is used as UV-A and/or UV-B protecting agent, wherein the ratio of wax:lignin is from 100:1 to 100:200 based on the dry weight of the wax and the lignin.

Advantageous embodiments of the above aspects are defined in the corresponding sub-claims.

According to one embodiment of the present invention, the composition consists of at least one wax; at least one lignin; at least one emulsifier; water; optionally calcium carbonate; and optionally a solvent.

According to one embodiment of the present invention, the ratio of wax:lignin in the composition is from 100:5 to 100:180, preferably from 100:10 to 100:150, and most preferably from 100:30 to 100:100 based on the dry weight of the wax and the lignin.

According to another embodiment of the present invention, the at least one wax is selected from the group consisting of carnauba wax, bees wax, paraffin wax, shellac wax, candelilla wax, ouricury wax, sugar-cane wax, soy wax, bayberry wax, petroleum waxes, laurel wax, rice bran wax and mixtures thereof and preferably is carnauba wax.

According to another embodiment of the present invention, the at least one lignin is selected from the group consisting of natural lignin, klason lignin, hydrolyzed lignin, milled wood lignin, soda lignin, organosolv lignin, kraft lignin, alkali lignin, sulphonated lignin and mixtures thereof and preferably is sulphonated lignin.

According to another embodiment of the present invention, the at least one emulsifier is selected from the group comprising PEG compounds, PEG-free emulsifier, silicone-based emulsifier, silicones, fatty acids and mixtures thereof.

According to another embodiment of the present invention, the at least one wax and the at least one lignin are each present in the composition in an amount from 0.1 to 45 wt.-% based on the total weight of the agricultural composition, preferably in an amount of 0.5 to 40 wt.-%, even more preferably in an amount of 0.8 to 30 wt.-% and most preferably in an amount of 1 to 20 wt.-% based on the total weight of the agricultural composition.

According to another embodiment of the present invention, the at least one emulsifier is present in the composition in an amount from 0.1 to 30 wt.-% based on the total weight of the agricultural composition, preferably in an amount of 1 to 15 wt.-%, and most preferably in an amount of 2 to 10 wt.-%, based on the total weight of the agricultural composition.

According to another embodiment of the present invention, the calcium carbonate is present in the agricultural composition, preferably in an amount from 0.1 to 10 wt.-% based on the total weight of the agricultural composition, more preferably in an amount from 0.3 to 3 wt.-%, even more preferably in an amount from 0.5 to 2 wt.-% and most preferably in an amount from 0.8 to 1.5 wt.-% based on the total weight of the agricultural composition.

According to another embodiment of the present invention, the calcium carbonate is selected from the group consisting of ground calcium carbonate (GCC), preferably marble, limestone, chalk and/or nanoGCC, precipitated calcium carbonate (PCC), preferably vaterite, calcite and/or aragonite, and mixtures thereof and most preferably the calcium carbonate is ground calcium carbonate.

According to another embodiment of the present invention, the solvent is present in the agricultural composition, and preferably the ratio of solvent:lignin in the composition is from 5:1 to 100:1, preferably from 10:1 to 20:1, and most preferably from 12:1 to 16:1 based on the dry weight of the solvent and the lignin.

According to another embodiment of the present invention, the at least one lignin is a water-soluble lignin, preferably sulphonated lignin, and no solvent is present in the agricultural composition.

According to another embodiment of the present invention, the composition is in the liquid form.

According to another embodiment of the present invention, the plants and parts thereof are fruits, vegetables, trees, seeds, leaves, wood, nuts, crops, crop plants and flowers.

It should be understood that for the purposes of the present invention, the following terms have the following meanings:

An “agricultural composition” in the meaning of the present invention is an aqueous composition that is used in agriculture, especially on plants and parts thereof.

“UV-A protection” and “UV-B protection” in the meaning of the present invention, refers to the protection from ultraviolet B (UV-B) radiation which ranges from 280 to 320 nm and the ultraviolet A (UV-A) radiation which ranges from >320 to 400 nm, both cause sunburn to plants and parts thereof.

The “melting point” of a substance in the meaning of the present invention is the temperature at which it changes state from solid to liquid. At the melting point the solid and liquid phase exist in equilibrium. The melting point of a substance depends on the pressure and is specified at a standard pressure of 1 atmosphere or 100 kPa.

The “density” or more precisely the “volumetric mass density” of a substance in the meaning of the present invention, is its mass per unit volume and is specified at a standard pressure of 1 atmosphere or 100 kPa and a temperature of 25° C.

“Water-insoluble” materials are defined as materials which, when 100 g of said material is mixed with 100 g deionized water and filtered on a filter having a 0.2 μm pore size at 20° C. under atmospheric pressure to recover the liquid filtrate, provide less than or equal to 0.1 g of recovered solid material following evaporation at 95 to 100° C. of 100 g of said liquid filtrate at ambient pressure. “Water-soluble” materials are thus defined as materials which, when 100 g of said material is mixed with 100 g deionized water and filtered on a filter having a 0.2 μm pore size at 20° C. under atmospheric pressure to recover the liquid filtrate, provide more than 0.1 g of recovered solid material following evaporation at 95 to 100° C. of 100 g of said liquid filtrate at ambient pressure.

The “particle size” of particulate materials, for example the calcium carbonate herein is described by its distribution of particle sizes dx. Therein, the value dx represents the diameter relative to which x % by weight of the particles have diameters less than dx. This means that, for example, the d20 value is the particle size at which 20 wt.-% of all particles are smaller than that particle size. The d50 value is thus the weight median particle size, i.e. 50 wt.-% of all grains are bigger and the remaining 50 wt. % are smaller than this particle size. For the purpose of the present invention the particle size is specified as weight median particle size d50 unless indicated otherwise. The d98 value is the particle size at which 98 wt.-% of all particles are smaller than that particle size. The d98 value is also designated as “top cut”. Particle sizes were determined by using a Sedigraph™ 5100 instrument of Micromeritics Instrument Corporation. The method and the instrument are known to the skilled person and are commonly used to determine the particle size of fillers and pigments. The measurements were carried out in an aqueous solution of 0.1 wt.-% Na4P2O7. The samples were dispersed using a high speed stirrer and sonicated.

A “specific surface area (SSA)” of a calcium carbonate-containing filler material in the meaning of the present invention is defined as the surface area of the calcium carbonate-containing filler material divided by its mass. As used herein, the specific surface area is measured by nitrogen gas adsorption using the BET isotherm (ISO 9277:2010) and is specified in m2/g.

The term “dry” material, is understood to be a material having less than 1.0% by weight of water relative to the material weight. The % water (equal to residual total moisture content) is determined according to the Coulometric Karl Fischer measurement method, wherein the material is heated to 220° C., and the water content released as vapour and isolated using a stream of nitrogen gas (at 100 ml/min) is determined in a Coulometric Karl Fischer unit.

Where the term “comprising” or “containing” is used in the present description and claims, it does not exclude other elements. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Where an indefinite or definite article is used when referring to a singular noun, e.g. “a”, “an” or “the”, this includes a plural of that noun unless something else is specifically stated.

Terms like “obtainable” or “definable” and “obtained” or “defined” are used interchangeably. This e.g. means that, unless the context clearly dictates otherwise, the term “obtained” does not mean to indicate that, e.g. an embodiment must be obtained by e.g. the sequence of steps following the term “obtained” even though such a limited understanding is always included by the terms “obtained” or “defined” as a preferred embodiment.

In the following, the details and preferred embodiments of the present inventive will be described in more detail. Embodiments that refer to the agricultural composition will also refer to the use of the agricultural composition and the use of the combination of at least one wax and at least one lignin and vice versa.

According to the present invention an agricultural composition for providing UV-A and/or UV-B protection to plants and parts thereof is provided, the composition comprising at least one wax, at least one lignin, at least one emulsifier, water, optionally calcium carbonate, and optionally a solvent; wherein the ratio of wax:lignin in the composition is from 100:1 to 100:200 based on the dry weight of the wax and the lignin.

### The at Least One Wax

According to the present invention at least one wax is present in the agricultural composition.

The term “at least one” wax in the meaning of the present invention means that the wax comprises, preferably consists of, one or more wax(es).

In one embodiment of the present invention, the at least one wax in the agricultural composition comprises, preferably consists of, one wax. Alternatively, the at least one wax comprises, preferably consists of, two or more waxes. For example, the at least one wax comprises, preferably consists of, two or three waxes.

Preferably, the at least one wax in the agricultural composition comprises, more preferably consists of, one wax.

A “wax” in the meaning of the present invention is defined as an organic compound that is a lipophilic, malleable solid at room temperature, e.g. at 25° C. The waxes melt at temperatures above 25° C. to give low viscosity liquids. Waxes according to the present invention are insoluble in water but soluble in organic, nonpolar solvents.

The wax can be a natural wax, synthetic wax, microcrystalline wax, silicone wax, and combinations thereof. It can be selected from waxes typically used in the field of sunscreens and agricultural compositions and are well known to a person skilled in the art.

The wax or waxes may be selected from among carnauba wax, candelilla wax and alfa wax, montan wax, polyethylene wax, paraffin wax, oxidized paraffin wax, ozokerite, shellac wax, ouricury wax, vegetable waxes such as olive tree wax, rice wax, sugar-cane wax, rice bran wax, laurel wax, soy wax, bayberry wax, petroleum waxes, hydrogenated jojoba wax or absolute waxes of flowers such as the essential wax of cassis flower sold by Bertin (France); animal waxes such as beeswax, or modified beeswax (cerabellina); other waxes or primary waxy materials: marine waxes such as that sold by Sophim under the name “M82™” natural or synthetic ceramides or polyethylene waxes. Other synthetic waxes include silicone waxes including but not limited to “Silky Wax 10™” sold by Dow Corning. Synthetic waxes may include clear synthetic waxes including but not limited to “Uniclear 80™” and “Uniclear 80V™” sold by Arizona Chemical Company. The vegetable waxes of carnauba (extract of Copemrica Cerifera), of candelilla (extract of Euphobies Cerifera and Pedilantus pavonis) and of alfa (extract of Stipa tenacissima), are commercial products.

According to a preferred embodiment of the present invention, the wax is a natural wax selected from the group consisting of carnauba wax, bees wax, paraffin wax, shellac wax, candelilla wax, ouricury wax, sugar-cane wax, soy wax, bayberry wax, petroleum waxes, laurel wax, rice bran wax and mixtures thereof.

Carnauba wax, also called Brazil wax or palm wax, is a wax of the leaves of the palm Copernicia prunifera, a plant native to and grown naturally only in northeastern Brazilian states. In its pure state, it usually comes in the form of hard yellow-brown flakes. It is obtained from the leaves of the carnauba palm by collecting and drying them, beating them to loosen the wax, then refining and bleaching the wax. As a food additive, its E number is E903 in the European Union. Carnauba consists mostly of aliphatic esters, diesters of 4-hydroxycinnamic acid, w-hydroxycarboxylic acids and fatty alcohols. It usually has a density of about 0.98 kg/1 and a melting point of between 80 to 90° C.

Bees wax (cera alba) is a natural wax produced by honey bees. The wax is formed into scales by eight wax-producing glands in the abdominal segments of worker bees, which discard it in or at the hive. Chemically, beeswax consists mainly of esters of fatty acids and various long-chain alcohols. Its main constituents are palmitate, palmitoleate, and oleate esters of long-chain (30-32 carbons) aliphatic alcohols. Bees wax is edible, having similar negligible toxicity to plant waxes, and is approved for food use in most countries and in the European Union under the E number E901. Bees wax has a melting point range of 60 to 70° C. and a density at 15° C. of about 0.95 kg/l.

Petroleum waxes are obtained from petroleum, including paraffin wax, microcrystalline wax, and petroleum jelly. Paraffin wax is a soft colorless solid, derived from petroleum, coal or shale oil, and mostly a byproduct from the refining of lubricating oil. It consists of a mixture of hydrocarbon molecules containing between twenty and forty carbon atoms. It is distinct from kerosene and other petroleum products that are sometimes called paraffin. It has a melting point between about 40 and 70° C. and a density of around 0.900 kg/l.

Shellac wax is a resin secreted by the female lac bug, on trees in the forests of India and Thailand. Shellac comes in many warm colours, ranging from a very light blonde (“platina”) to a very dark brown (“garnet”), with many varieties of brown, yellow, orange and red in between. The colour is influenced by the sap of the tree the lac bug is living on and by the time of harvest. Main constituents of shellac wax are hyroxycarboxylic acids such as aleuritic acid or shellolic acid, which are unsaturated acids that contain aldehyde groups or are present in esterified form. It has a melting point between about 65 and 85° C. and a density of around 0.950 kg/l.

Candelilla wax is a wax derived from the leaves of the small Candelilla shrub native to northern Mexico and the southwestern United States, Euphorbia cerifera and Euphorbia antisyphilitica, from the family Euphorbiaceae. It is yellowish-brown, hard, brittle, aromatic, and opaque to translucent. Candelilla wax consists of mainly hydrocarbons (chains with 29-33 carbons), esters of higher molecular weight, free acids and resins, mainly triterpenoid esters). The high hydrocarbon content distinguishes this wax from carnauba wax. As a food additive, candelilla wax has the E number E 902 and is used as a glazing agent. It has a melting point of 68-73° C. and a density of about 0.988 kg/l.

Ouricury wax is a brown-colored wax obtained from the leaves of a Brazilian feather palm Syagrus coronata by scraping the leaf surface. It has a greenish brown color that is difficult to bleach. Ouricury wax contains about 6% triterpenes. It has a melting point of 75 to 85° C. and a density of about 0.970 kg/l.

Sugarcane wax is a wax extracted from sugarcane. During the production of sugar there remains a filter residue, the so-called bagasse. The sugar cane wax is obtained from this filter residue. In that process, plant residues and chlorophyll are separated from the sugarcane. Sugarcane wax consists of about 70% of alcohols of long-chain hydrocarbons having chain lengths of C18 to C32, wax acids having chain lengths of C18 to C32, ω-hydroxycarboxylic acids and aromatic carboxylic acids, but also fatty alcohols (wax alcohols) and diols are alcohol components. Sugarcane wax can be used in the food industry, for example in chewing gums. It has a melting point of 65 to 85° C. and a density of about 0.850 kg/l.

Soy wax is a vegetable wax made from the oil of soybeans. After harvesting, the beans are cleaned, cracked, de-hulled, and rolled into flakes. The oil is then extracted from the flakes and hydrogenated. It has a melting point of 40 to 85° C. and a density of about 0.850 kg/1 to 0.950 kg/l.

Bayberry wax is an aromatic green vegetable wax. It is removed from the surface of the fruit of the bayberry (wax-myrtle) shrub (ex. Myrica cerifera) by boiling the fruits in water and skimming the wax from the surface of the water. It is made up primarily of esters of lauric, myristic, and palmitic acid. It has a melting point of 35 to 55° C. and a density of about 0.977 kg/1 to 0.995 kg/l.

Laurel wax is a vegetable wax obtained from the fruit of the Myrica Pubescens and commonly known as laurel wax. The wax is normally water extracted and greenish-white in color. It is a low melting range, hard wax with a high saponification value and has a melting point of 35 to 45° C. and a density of about 0.8 kg/1 to 0.9 kg/l.

Rice bran wax is the vegetable wax extracted from the bran oil of rice (Oryza sativa). The main components of rice bran wax are aliphatic acids (wax acids) and higher alcohol esters. Rice bran wax also contains constituents such as free fatty acids (palmitic acid), squalene and phospholipids. It has a melting point of 75 to 90° C. and a density of about 0.970 kg/l.

According to one embodiment of the present invention the at least one wax is a mixture of two or more waxes and preferably is a mixture of two waxes, for example, carnauba wax and a further wax, for example, soy wax or paraffin wax.

According to a preferred embodiment of the present invention, the at least one wax consists only of one wax, preferably selected from carnauba wax, bees wax, paraffin wax, shellac wax, candelilla wax, ouricury wax, sugar-cane wax, soy wax, bayberry wax, petroleum waxes, laurel wax or rice bran wax and most preferably consist merely of carnauba wax.

According to another embodiment of the present invention the at least one wax has a melting point of above 25° C. preferably above 30° C. and below 120° C., even more preferably between 35° C. to 100° C. and most preferably between 40° C. and 90° C.

According to another preferred embodiment of the present invention, the at least one wax has a density of about 0.700 kg/1 to 1.100 kg/1, preferably of about 0.750 kg/1 to 1.050 kg/1 and most preferably of about 0.800 to 1.000 kg/l.

According to another preferred embodiment of the present invention, the at least one wax is present in the composition in an amount from 0.1 to 45 wt.-% based on the total weight of the agricultural composition, preferably in an amount of 0.5 to 40 wt.-%, even more preferably in an amount of 0.8 to 30 wt.-% and most preferably in an amount of 1 to 20 wt.-% based on the total weight of the agricultural composition.

### The at Least on Lignin

According to the present invention at least one lignin is present in the agricultural composition.

The term “at least one” lignin in the meaning of the present invention means that the lignin comprises, preferably consists of, one or more lignin(s).

In one embodiment of the present invention, the at least one lignin in the agricultural composition comprises, preferably consists of, one lignin. Alternatively, the at least one lignin comprises, preferably consists of, two or more lignins. For example, the at least one lignin comprises, preferably consists of, two or three lignins.

Preferably, the at least one lignin in the agricultural composition comprises, more preferably consists of, one lignin.

A “lignin” in the meaning of the present invention is defined as an organic biopolymer which is obtained from woods and plants. It is a cross-linked polymer with molecular masses in excess of 10000 u. Lignin is hydrophobic and rich in aromatic subunits and mainly comprises a crosslinked network 4-hydroxy-3-methoxyphenylpropane, 3,5-dimethoxy-4-hydroxyphenylpropane, and 4-hydroxyphenylpropane.

Lignin is known to the skilled person and commercially available, for example from Domsjö under the trade name Domsjö Lignin DS10.

Plant lignins can be broadly divided into three classes: softwood (gymnosperm), hardwood (angiosperm) and grass or annual plant (graminaceous) lignin. Three different phenylpropane units, or monolignols, are responsible for lignin biosynthesis. Guaiacyl lignin is composed principally of coniferyl alcohol units, while guaiacyl-syringyl lignin contains monomeric units from coniferyl and sinapyl alcohol. In general, guaiacyl lignin is found in softwoods while guaiacyl-syringyl lignin is present in hardwoods. Graminaceous lignin is composed mainly of p-coumaryl alcohol units. Lignin polymerization is initiated by oxidation of the phenylpropane phenolic hydroxyl groups. Stabilization of the radical occurs by coupling to another radical in any of the positions of the unpaired electron.

According to one embodiment of the present invention, the at least one lignin is selected from the group consisting of natural lignin, klason lignin, hydrolyzed lignin, milled wood lignin, soda lignin, organosolv lignin, kraft lignin, alkali lignin, sulphonated lignin and mixtures thereof.

Natural lignin is the lignin that is present in plant tissues and is also known as native lignin.

Klason lignin is the acid insoluble lignin content in natural lignin. It is obtained by pre-hydrolysis of natural lignin in H2SO4, hydrolyzing the mixture at high temperatures and filtration. The retentate comprises the klason lignin. The Klason process is known to the skilled person.

Hydrolyzed lignin is obtained by refluxing lignin or lignocellulose with HCl in a dioxane/water composition. The treatment results in the degradation of lignin with formation of substantial amounts of arylpropanes and the majority of the acidolysis monomers originate from arylglycerol β-aryl ether structure.

Milled wood lignin (MWL) also known as Bjorkman lignin is obtained by grinding wood meal in a ball mill either dry or in the presence of nonswelling solvents such as, for example, toluene, wherein the cell structure of the wood is destroyed. A portion of lignin can be obtained from the suspension by extraction with a dioxane-water mixture. The Björkman process is known to the skilled person.

Kraft lignin is the lignin obtained from the Kraft process also known as kraft pulping or sulfate process. The process is for the conversion of wood into wood pulp, which consists of almost pure cellulose fibers, the main component of paper and is known to the skilled person. The Kraft process entails treatment of wood chips with a hot mixture of water, sodium hydroxide (NaOH), and sodium sulfide (Na2S), known as white liquor, that breaks the bonds that link lignin, hemicellulose, and cellulose. The technology entails several steps, both mechanical and chemical.

Lignosulfonate also known as sulphonated lignin are water-soluble anionic polyelectrolyte polymers. They are obtained from wood by treating wood at elevated temperatures with solutions containing sulfur dioxide and/or hydrogen sulfite ions. This process is also known to the skilled person.

Alkali lignin is obtained by treating wood with alkaline species such as NaOH, or with a mixture of NaOH and Na2SO4.

Soda lignin is obtained from the soda process which involves heating fibrous wood material in a pressurized reactor to 140-170° C. in the presence of 13-16% sodium hydroxide (i.e. soda), also known as cooking liquor. In the process, lignin is separating from the cellulose, and is suspended in the liquid phase, which is called black liquor. The black liquor therefore contains lignin and sodium hydroxide (soda) and is known as soda lignin.

Organosolv lignin is obtained by the organosolv process. The organosolv process includes extracting lignin from lignocellulosic biomass using organic solvents typically with an acidic catalyst. Organosolv lignin does not comprise sulfur or sulfonate groups and has a molecular weight of about 1000 to 2000 g/mole.

According to one embodiment of the present invention the at least one lignin is a mixture of two or more lignins e.g. is a mixture of two lignins, for example, sulphonated lignin and a further lignin, for example, kraft lignin or natural lignin.

According to a preferred embodiment of the present invention, the at least one lignin consist only of one lignin, preferably selected from natural lignin, klason lignin, hydrolyzed lignin, milled wood lignin, soda lignin, organosolv lignin, kraft lignin, alkali lignin or sulphonated lignin and most preferably consist merely of sulphonated lignin.

According to one embodiment of the present invention the at least one lignin is water soluble. According to another embodiment of the present invention the at least one lignin is water insoluble. Preferably, the at least one lignin is water soluble and most preferably the at least one lignin is water soluble sulphonated lignin.

According to another embodiment of the present invention the at least one lignin has a molecular mass above 10000 u, preferably between 15000 and 1000000 u even more preferably between 50000 to 800000 u and most preferably between 100000 and 500000 u.

According to another preferred embodiment of the present invention, the at least one lignin is present in the composition in an amount from 0.1 to 45 wt.-% based on the total weight of the agricultural composition, preferably in an amount of 0.5 to 40 wt.-%, even more preferably in an amount of 0.8 to 30 wt.-% and most preferably in an amount of 1 to 20 wt.-% based on the total weight of the agricultural composition.

According to one embodiment of the present invention, the at least one wax and the at least on lignin are each present in the composition in an amount from 0.1 to 45 wt.-% based on the total weight of the agricultural composition, preferably in an amount of 0.5 to 40 wt.-%, even more preferably in an amount of 0.8 to 30 wt.-% and most preferably in an amount of 1 to 20 wt.-% based on the total weight of the agricultural composition.

The ratio of wax:lignin in the composition is from 100:1 to 100:200 based on the dry weight of the wax and the lignin. Preferably the ratio of wax:lignin in the composition is from 100:5 to 100:180, more preferably from 100:10 to 100:150, and most preferably from 100:30 to 100:100 based on the dry weight of the wax and the lignin. The inventors surprisingly found out that the combination of at least one wax and at least one lignin in the inventive agricultural composition provides sufficient or improved UV-B and/or UV-A protection to plants and parts thereof.

### The at Least One Emulsifier

According to the present invention at least one emulsifier is present in the agricultural composition.

The term “at least one” emulsifier in the meaning of the present invention means that the emulsifier comprises, preferably consists of, one or more emulsifier(s).

In one embodiment of the present invention, the at least one emulsifier in the agricultural composition comprises, preferably consists of, one emulsifier. Alternatively, the at least one emulsifier comprises, preferably consists of, two or more emulsifiers. For example, the at least one emulsifier comprises, preferably consists of, two or three emulsifiers.

An “emulsifier” in the meaning of the present invention is a chemical agent that comprises a hydrophilic and a hydrophobic part. Preferably, the emulsifier comprises a hydrophilic head and a hydrophobic tail. The emulsifier is used to prepare stable emulsions or dispersion of hydrophilic and hydrophobic liquids, preferably of water and at least one wax.

The at least one emulsifier of the present invention can be any available emulsifier that is able to provide a stable agricultural composition according to the present invention. A “stable” agricultural composition in the meaning of the present invention is a dispersion or emulsion that resists change in its structural properties for at least 5 min, preferably for at least 30 min, more preferably at least 1h, even more preferably at least 10 h and most preferably at least 1 day.

The skilled person knows how to choose a suitable emulsifier, based on the used wax(es) and lignin(s) and the optional calcium carbonate(s) and the optional solvent.

The at least one emulsifier may be an ionic emulsifier or a non-ionic emulsifier or an amphoteric emulsifier. In case the at least one emulsifier is ionic it can be cationic or anionic. According to a preferred embodiment the at least one emulsifier is non-ionic.

The at least one emulsifier can be of natural vegetable origin, for example, fatty acids such as polyglycerol ester or can be synthetic.

According to one embodiment of the present invention the at least one emulsifier is selected from the group comprising PEG compounds, PEG-free emulsifier, silicone-based emulsifier, silicones, fatty acids and mixtures thereof.

For example, the emulsifier may be selected from the group comprising PEG compounds such as PEG-8 myristate, PEG-30 glyceryl cocoate, PEG-80 glyceryl cocoate, PEG-15 soyamide/IPDI copolymer, PEG-40 sorbitan peroleate, PEG-150 stearate and mixtures thereof, PEG-free emulsifiers such as carbomer, carboxymethylcellulose, ceresin (aka mineral wax), diethanolamine (DEA), isopropyl stearate, isopropyl laurate, isopropyl palmitate, isopropyl oleate, polysorbate 20, polysorbate 60, polysorbate 80, propylene glycol, sorbitan stearate, sorbitan laurate, sorbitan palmitate, sorbitan oleate, steareth-20, triethanolamine (TEA), cetearyl alcohol, cetearyl wheat bran glycosides, cetearyl wheat straw glycosides, decyl glucoside, lecithin, vegetable glycerin, xanthan gum, coco glucoside, coconut alcohol, arachidyl alcohol, behenyl alcohol, arachidyl glucoside, stearic acid and mixtures thereof.

According to a preferred embodiment of the present invention the at least one emulsifier is a PEG-free emulsifier and preferably is selected from the group consisting of triethanolamine (TEA), stearic acid and mixtures thereof.

In one embodiment of the present invention, the at least one emulsifier in the agricultural composition comprises, preferably consists of, one emulsifier. For example, the at least one emulsifier is a PEG-free emulsifier, preferably triethanolamine or stearic acid. Alternatively, the at least one emulsifier comprises, preferably consists of, two or more emulsifiers. For example, the at least one emulsifier comprises, preferably consists of, two emulsifiers. According to a preferred embodiment the at least one emulsifier is a mixture of triethanolamine and stearic acid.

According to one embodiment of the present invention, the at least one emulsifier is present in the composition in an amount from 0.1 to 30 wt.-% based on the total weight of the agricultural composition, preferably in an amount of 1 to 15 wt.-%, and most preferably in an amount of 2 to 10 wt.-%, based on the total weight of the agricultural composition.

### Water

According to the present invention water is present in the agricultural composition.

The water of the present invention may be selected from drinking water, process water, demineralized water, distilled water, rain water, recycled water, river water and mixtures thereof. According to a preferred embodiment of the present invention the water present in the agricultural composition is drinking water.

Drinking water, also known as potable water, is water that is safe to drink or to use for food preparations. Rain water/river water is obtained from rain/rivers. Recycled water is water that has been recycled and can be used in agriculture. Process water is water which is not considered drinkable and is basically used in relation to industrial plants, industrial processes and production facilities. Demineralized water is specially purified water that has had most or all of its mineral and salt ions removed, such as calcium, magnesium, sodium, chloride, sulphate, nitrate and bicarbonate. It is also known as deionized water. Distilled water is water that has been boiled into vapor and condensed back into liquid in a separate container.

According to one embodiment of the present invention the water is present in the composition in an amount from 10 to 99.9 wt.-% based on the total weight of the agricultural composition, preferably in an amount of 30 to 95 wt.-%, even more preferably in an amount of 40 to 90 wt.-% and most preferably in an amount of 50 to 85 wt.-% based on the total weight of the agricultural composition.

### Calcium Carbonate

According to the present invention calcium carbonate is optionally present in the agricultural composition.

It is appreciated that the amount of calcium in the calcium carbonate is at least 50 mol.-%, based on the total amount of the calcium carbonate, preferably at least 70 mol.-%, more preferably at least 90 mol.-% and most preferably at least 99 mol.-%. The calcium carbonate may comprise further earth alkali compounds such as Mg.

According to a preferred embodiment of the present invention the calcium carbonate is selected from the group consisting of ground calcium carbonate (GCC), preferably marble, limestone, and/or chalk, and/or nanoGCC, precipitated calcium carbonate (PCC), preferably vaterite, calcite and/or aragonite and mixtures thereof.

GCC is understood to be a naturally occurring form of calcium carbonate, mined from sedimentary rocks such as limestone or chalk, or from metamorphic marble rocks and processed through a treatment such as grinding, screening and/or fractionizing in wet and/or dry form, for example by a cyclone or classifier. In one embodiment of the present invention, the GCC is selected from the group comprising marble, chalk, limestone and/or nanoGCC and mixtures thereof.

“Nano ground calcium carbonate” (nanoGCC) in the meaning of the present invention refers to ground calcium carbonate in the form of particles in the nanometer size range, namely in an unbound state or as an aggregate or as an agglomerate and where for 50% or more of the particles in the number size distribution, one or more external dimensions is/are in the size range 50 nm to 950 nm. Preferably, for 60% or more, more preferably for 80% or more and most preferably for 99% or more, of the particles in the number size distribution, one or more external dimensions is/are in the size range 50 nm to 950 nm.

By contrast, calcium carbonate of the PCC type includes synthetic calcium carbonate products obtained by carbonation of a slurry of calcium hydroxide, commonly referred to in the art as a slurry of lime or milk of lime when derived from finely divided calcium oxide particles in water or by precipitation out of an ionic salt solution. PCC may be rhombohedral and/or scalenohedral and/or aragonitic; preferred synthetic calcium carbonate or precipitated calcium carbonate comprising aragonitic, vateritic or calcitic mineralogical crystal forms or mixtures thereof.

In one preferred embodiment, the at least one calcium carbonate is ground calcium carbonate and preferably marble.

The optional calcium carbonate is preferably in the form of a particulate material, and may have a particle size distribution as conventionally employed for the material(s) involved in the type of product to be produced. In general, it is preferred that the optional calcium carbonate has a weight median particle size d50 value in the range from 0.1 to 20 μm. For example, the at least one calcium carbonate has a weight median particle size d50 from 0.25 μm to 10 μm and preferably from 0.5 μm to 8 μm.

Additionally or alternatively, the at least one calcium carbonate has a top cut (d98) of ≤100 μm. For example, the at least one calcium carbonate has a top cut (d98) of ≤60 μm, preferably of ≤40 μm and most preferably of ≤20 μm.

Additionally or alternatively the at least one calcium carbonate has a BET specific surface area of from 0.5 and 100 m2/g as measured by the BET nitrogen method. For example, the at least one calcium carbonate has a specific surface area (BET) of from 0.5 to 50 m2/g, more preferably of from 0.5 to 35 m2/g and most preferably of from 0.5 to 10 m2/g as measured by the BET nitrogen method.

According to another embodiment, the at least one calcium carbonate is ground calcium carbonate and preferably nanoGCC.

In the case the optional calcium carbonate is nanoGCC, it is preferably in the form of a particulate material, and may have a particle size distribution as conventionally employed for the material(s) involved in the type of product to be produced. In general, it is preferred that the nanoGCC has a weight median particle size d50 value in the range from 50 to 950 nm. For example, the nanoGCC has a weight median particle size d50 from 150 nm to 800 nm and preferably from 200 nm to 600 nm.

Additionally or alternatively, the nanoGCC has a top cut (d98) of ≤950 nm. For example, the nanoGCC has a top cut (d98) of ≤800 nm, preferably of ≤700 nm and most preferably of ≤600 nm.

Additionally or alternatively the nanoGCC has a BET specific surface area of from 0.5 and 100 m2/g as measured by the BET nitrogen method. For example, the nanoGCC has a specific surface area (BET) of from 0.5 to 50 m2/g, more preferably of from 0.5 to 35 m2/g and most preferably of from 0.5 to 10 m2/g as measured by the BET nitrogen method.

The optional GCC can be added as a dry material or can be added in wet form. For example, the optional GCC can be added in wet form, for example, in form of a slurry. In that case, the amount of water in the agricultural composition has to be adjusted based on the solid content of the GCC slurry. Alternatively, the optional GCC can be added as dry material. It is preferred that the optional calcium carbonate is a dry ground material, a material being wet ground and dried or a mixture of the foregoing materials. In general, the grinding step can be carried out with any conventional grinding device, for example, under conditions such that refinement predominantly results from impacts with a secondary body, i.e. in one or more of: a ball mill, a rod mill, a vibrating mill, a roll crusher, a centrifugal impact mill, a vertical bead mill an attrition mill, a pin mill, a hammer mill, a pulveriser, a shredder, a de-clumper, a knife cutter, or other such equipment known to the skilled man.

In case the optional calcium carbonate is a wet ground calcium carbonate, the grinding step may be performed under conditions such that autogenous grinding takes place and/or by horizontal ball milling, and/or other such processes known to the skilled man. The wet processed ground calcium carbonate thus obtained may be washed and dewatered by well known processes, e.g. by flocculation, filtration or forced evaporation prior to drying. The subsequent step of drying may be carried out in a single step such as spray drying, or in at least two steps, e.g. by applying a first heating step to the calcium carbonate in order to reduce the associated moisture content to a level which is not greater than about 1 wt.-%, based on the total dry weight of the calcium carbonate. The residual total moisture content of the filler can be measured by the Karl Fischer coulometric titration method, desorbing the moisture in an oven at 195° C. and passing it continuously into the KF coulometer (Mettler Toledo coulometric KF Titrator C30, combined with Mettler oven DO 0337) using dry N2 at 100 ml/min for 10 min. The residual total moisture content can be determined with a calibration curve and also a blind of 10 min gas flow without a sample can be taken into account. The residual total moisture content may be further reduced by applying a second heating step to the calcium carbonate. In case said drying is carried out by more than one drying steps, the first step may be carried out by heating in a hot current of air, while the second and further drying steps are preferably carried out by an indirect heating in which the atmosphere in the corresponding vessel comprises a surface treatment agent. It is also common that the calcium carbonate is subjected to a beneficiation step (such as a flotation, bleaching or magnetic separation step) to remove impurities.

In one embodiment of the present invention, the optional calcium carbonate comprises a dry ground calcium carbonate. In another preferred embodiment, the optional calcium carbonate is a material being wet ground in a horizontal ball mill, and subsequently dried by using the well known process of spray drying.

The optional calcium carbonate may comprise, one or more, for example, two or three calcium carbonates. According to a preferred embodiment, the optional calcium carbonate comprises only one calcium carbonate, preferably ground calcium carbonate and most preferably marble.

According to one embodiment of the present invention the calcium carbonate is present in the agricultural composition, preferably in an amount from 0.1 to 10 wt.-% based on the total weight of the agricultural composition, more preferably in an amount from 0.3 to 3 wt.-%, even more preferably in an amount from 0.5 to 2 wt.-% and most preferably in an amount from 0.8 to 1.5 wt.-% based on the total weight of the agricultural composition.

### Solvent

According to the present invention a solvent is optionally present in the agricultural composition. Preferably, the solvent is present when a non-water soluble lignin is used.

A solvent in the meaning of the present invention is any compound that is able to dissolve at least one lignin and preferably a non-water soluble lignin. The solvent is different from water.

According to a preferred embodiment the solvent is miscible with water in any ration, preferably the ratio of water:solvent is from 100:0.1 to 100:200, preferably from 100:1 to 100:150, more preferably from 100:5 to 100:120 and most preferably from 100:10 to 100:100, based on the weight of the water and the dry weight of the solvent.

According to one embodiment of the present invention, the solvent is selected from the group consisting of ethylene glycol, ethyl acetate, glycerol, γ-valerolactone, polyethylene glycol, polypropylene glycol and mixtures thereof.

Ethylene glycol also known as ethane-1,2-diol is an organic compound with the chemical formula (CH2OH)2. It is an odorless, colorless, sweet-tasting, viscous liquid.

Ethyl acetate is an organic compound with the formula CH3—COO—CH2—CH3. It is a colorless liquid and has a characteristic sweet smell. Ethyl acetate is the ester of ethanol and acetic acid.

Glycerol is also called glycerine or glycerin or propane-1,2,3-triol and is a simple polyol compound. It is a colorless, odorless, viscous liquid that is sweet-tasting and non-toxic. It has the chemical formula CH2OH—CHOH—CH2OH.

γ-valerolactone is an organic compound with the formula C5H8O2. This colorless liquid is chiral but is usually used as the racemate. It is readily obtained from cellulosic biomass and is a potential fuel and green solvent.

Polyethylene glycol is a polyether compound with many applications, from industrial manufacturing to medicine. PEG is also known as polyethylene oxide (PEO) or polyoxyethylene (POE), depending on its molecular weight. The structure of PEG is commonly expressed as H—(O—CH2—CH2)n—OH.

Polypropylene glycol or polypropylene oxide is the polymer of propylene glycol. Chemically it is a polyether. The structure of PPG is commonly expressed as H—(O—CHCH3—CH2)n—OH.

According to a preferred embodiment of the present invention the solvent is ethylene glycol.

According to one embodiment of the present invention the solvent is present in the agricultural composition, preferably in an amount from 0.1 to 40 wt.-% based on the total weight of the agricultural composition, more preferably in an amount from 1 to 35 wt.-%, even more preferably in an amount from 2 to 30 wt.-% and most preferably in an amount from 3 to 25 wt.-% based on the total weight of the agricultural composition.

According to another preferred embodiment of the present invention, the solvent is present in the agricultural composition, and preferably the ratio of solvent:lignin in the composition is from 5:1 to 100:1, preferably from 10:1 to 20:1, and most preferably from 12:1 to 16:1 based on the dry weight of the ethylene glycol and the lignin.

### The Agricultural Composition

According to one embodiment of the present invention the agricultural composition for providing UV-A and/or UV-B protection to plants and parts thereof comprises at least one wax, at least one lignin, at least one emulsifier and water, wherein the ratio of wax:lignin in the composition is from 100:1 to 100:200 based on the dry weight of the wax and the lignin.

According to another embodiment of the present invention the agricultural composition for providing UV-A and/or UV-B protection to plants and parts thereof consists of at least one wax, at least one lignin, at least one emulsifier and water, wherein the ratio of wax:lignin in the composition is from 100:1 to 100:200 based on the dry weight of the wax and the lignin.

According to another embodiment of the present invention the agricultural composition for providing UV-A and/or UV-B protection to plants and parts thereof comprises at least one wax, at least one lignin, at least one emulsifier, water and calcium carbonate, wherein the ratio of wax:lignin in the composition is from 100:1 to 100:200 based on the dry weight of the wax and the lignin.

According to another embodiment of the present invention the agricultural composition for providing UV-A and/or UV-B protection to plants and parts thereof consists of at least one wax, at least one lignin, at least one emulsifier, water and calcium carbonate, wherein the ratio of wax:lignin in the composition is from 100:1 to 100:200 based on the dry weight of the wax and the lignin.

According to another embodiment of the present invention the agricultural composition for providing UV-A and/or UV-B protection to plants and parts thereof comprises at least one wax, at least one lignin, at least one emulsifier, water and a solvent, wherein the ratio of wax:lignin in the composition is from 100:1 to 100:200 based on the dry weight of the wax and the lignin.

According to another embodiment of the present invention the agricultural composition for providing UV-A and/or UV-B protection to plants and parts thereof consists of at least one wax, at least one lignin, at least one emulsifier, water and a solvent, wherein the ratio of wax:lignin in the composition is from 100:1 to 100:200 based on the dry weight of the wax and the lignin.

According to another embodiment of the present invention the agricultural composition for providing UV-A and/or UV-B protection to plants and parts thereof comprises at least one wax, at least one lignin, at least one emulsifier, water, calcium carbonate and a solvent, wherein the ratio of wax:lignin in the composition is from 100:1 to 100:200 based on the dry weight of the wax and the lignin.

According to another embodiment of the present invention the agricultural composition for providing UV-A and/or UV-B protection to plants and parts thereof consists of at least one wax, at least one lignin, at least one emulsifier, water, calcium carbonate and a solvent, wherein the ratio of wax:lignin in the composition is from 100:1 to 100:200 based on the dry weight of the wax and the lignin.

The inventors surprisingly found out that the foregoing agricultural compositions provides sufficient or improved UV-B and/or UV-A protection to plants and parts thereof, especially to fruits. Especially, the inventors surprisingly found that when at least one wax is used in combination with at least one lignin, wherein the ratio of wax:lignin in the composition is from 100:1 to 100:200 based on the dry weight of the wax and the lignin, the agricultural composition provides sufficient or improved UV-B and/or UV-A protection to plants and parts thereof.

UV-B and/or UV-A protection can be measured by transmittance and absorbance measurements. Ultraviolet-visible spectroscopy or ultraviolet-visible spectrophotometry and Near Infrared spectroscopy (UV-Vis or UV/Vis and NIR) refers to absorption spectroscopy, transmittance spectroscopy or reflectance spectroscopy in the ultraviolet-visible and near infrared spectral region. This means it uses light in the visible and adjacent ranges. The absorption, transmission or reflectance in this range directly affects the perceived color of the chemicals involved. In this region of the electromagnetic spectrum, atoms and molecules undergo electronic transitions. As used herein, the transmittance and absorbance are measured by a double beam PerkinElmer Lambda 950 UV/Vis/NIR spectrometer equipped with a 150 mm integrating sphere PMT—InGaAs detector.

According to one embodiment of the present invention the agricultural composition of the present invention has an improved UV-B and/or UV-A protection to plants and parts thereof, especially to fruits, compared to an identical agricultural composition that comprises merely at least one wax or at least one lignin.

An “identical agricultural composition” in the meaning of the present invention refers to an agricultural composition that consists of the same ingredients in the same amounts than the inventive agricultural composition with the exception, that the composition does not comprise a combination of at least one wax and at least one lignin, but only one component. The missing component is replaced by water.

According to one preferred embodiment of the present invention the agricultural composition of the present invention has an improved transmittance and absorbance in the range of 280 nm to 320 nm, compared to an identical agricultural composition that comprises merely at least one wax or at least one lignin, or alternatively in the range of >320 nm to 400 nm, and most preferably in the range of 280 nm to 400 nm.

The inventors surprisingly found that the agricultural compositions of the present invention are sprayable and they stick to the plants and parts thereof and don't get washed off easily by rain.

According to another embodiment of the present invention, the agricultural composition of the present invention is in liquid form, preferably in form of an aqueous dispersion or emulsion. According to another embodiment of the present invention, the agricultural composition of the present invention is in liquid form, preferably in form of an aqueous suspension or slurry. “Aqueous” in the meaning of the present invention means that the composition comprises water and optionally a solvent as defined above.

A “dispersion” in the meaning of the present invention refers to a system, wherein discrete particles of one material are dispersed in a continuous phase of another material. An “emulsion” in the meaning of the present invention refers to a mixture of two or more liquids that are normally immiscible and wherein one liquid is dispersed in the other liquid.

A “suspension” or “slurry” in the meaning of the present invention comprises undissolved solids and water, and optionally further additives, and usually contains large amounts of solids and, thus, is more viscous and can be of higher density than the liquid from which it is formed.

Furthermore, the inventors surprisingly found that the agricultural composition of the present invention is translucent or at least provides only a pale film or shimmer on the plants and parts thereof that are treated with such a composition.

According to a preferred embodiment of the present invention, no calcium carbonate is present in the agricultural composition. In that case the agricultural composition for providing UV-A and/or UV-B protection to plants and parts thereof consists of at least one wax, at least one lignin, at least one emulsifier, water and optionally a solvent, wherein the ratio of wax:lignin in the composition is from 100:1 to 100:200 based on the dry weight of the wax and the lignin. In that case the inventive agricultural composition is translucent and there is no optical impairment on the plants and parts thereof. Alternatively, the agricultural composition for providing UV-A and/or UV-B protection to plants and parts thereof comprises at least one wax, at least one lignin, at least one emulsifier, water and optionally a solvent, wherein the ratio of wax:lignin in the composition is from 100:1 to 100:200 based on the dry weight of the wax and the lignin with the provision that no calcium carbonate or other non-solvent particulate material is present in the composition.

According to another preferred embodiment of the present invention, calcium carbonate is present in the agricultural composition and is preferably ground calcium carbonate, for example marble or nanoGCC. In that case the agricultural composition for providing UV-A and/or UV-B protection to plants and parts thereof comprises, preferably consists of at least one wax, at least one lignin, at least one emulsifier, water, calcium carbonate, preferably ground calcium carbonate, for example marble or nanoGCC and optionally a solvent, wherein the ratio of wax:lignin in the composition is from 100:1 to 100:200 based on the dry weight of the wax and the lignin. NanoGCC is a very fine particulate material which is hardly detectable by human eye and, therefore, the inventive agricultural composition is translucent and with reduced optical disturbance on the plants and parts thereof.

According to another preferred embodiment of the present invention, the at least one lignin is a water-soluble lignin, preferably sulphonated lignin, and no solvent is present in the agricultural composition.

According to another preferred embodiment of the present invention the at least one wax is carnauba wax and/or the at least one lignin is water soluble lignin and preferably sulphonated lignin.

According to an exemplified embodiment of the present invention, the agricultural composition for providing UV-A and/or UV-B protection to plants and parts thereof comprises, preferably consists of carnauba wax, at least one lignin and preferably sulphonated lignin, at least one emulsifier, water, optionally calcium carbonate, and optionally a solvent; wherein the ratio of carnauba wax:lignin in the composition is from 100:1 to 100:200 based on the dry weight of the carnauba wax and the lignin.

According to another exemplified embodiment of the present invention, the agricultural composition for providing UV-A and/or UV-B protection to plants and parts thereof comprises, preferably consists of carnauba wax, sulphonated lignin, at least one emulsifier, and water; wherein the ratio of carnauba wax:sulphonated lignin in the composition is from 100:1 to 100:200 based on the dry weight of the carnauba wax and the sulphonated lignin.

The compositions of the present invention can be easily and quickly produced, are cheap and especially easy to handle. More precisely, the agricultural compositions of the present invention can be easily produced by mixing the components of inventive composition consecutively in any order or simultaneously.

In one embodiment, mixing is carried out at a temperature in the range from 15 to 120° C., more preferably from 20 to 110° C. and most preferably from 30 to 100° C. According to a preferred embodiment, mixing is carried out at a temperature above the melting point of the at least on wax.

Preferably the mixing is done consecutively and/or at a temperature above the melting point of the at least one wax. For example, the at least one wax is heated above the melting point and afterwards mixed with the at least one emulsifier. Afterwards, the water is added under mixing to the mixture and finally, the lignin is added under mixing conditions.

In case calcium carbonate is present in the agricultural composition, said calcium carbonate may be added at any stage when preparing the agricultural composition and preferably is added as the last component to the mixture.

In case a solvent, for example ethylene glycol is present in the agricultural composition, said solvent may be added at any stage when preparing the agricultural composition and preferably is premixed with the lignin and afterwards this mixture may be added at any stage when preparing the agricultural composition.

The mixing may be carried out under conventional mixing conditions. The skilled person will adapt these mixing conditions (such as the configuration of mixing pallets and mixing speed) according to his process equipment. It is appreciated that any mixing method which would be suitable to form an agricultural composition may be used.

### Use of the Agricultural Composition

The inventive agricultural composition is used for UV-A and/or UV-B protection of plants and parts thereof.

This can be easily done by applying the inventive agricultural composition to plants and parts thereof by any suitable method known to the skilled person, for example, by spraying, painting or dipping. According to a preferred method the inventive agricultural composition is sprayed onto plants and parts thereof. Equipment for spraying the agricultural composition is known to the skilled person and commercially available.

According to one embodiment of the present invention, the plants and parts thereof are fruits, vegetables, trees, seeds, leaves, wood, nuts, crops, crop plants and flowers and especially are fruits like apples, oranges, citrons, cherries, pears, plums, bananas or mango.

As already set out above the inventors surprisingly found out that the foregoing agricultural composition provides sufficient UV-B and/or UV-A protection to plants and parts thereof, especially to fruits. Especially, the inventors surprisingly found that when at least one wax is used in combination with at least one lignin, wherein the ratio of wax:lignin in the composition is from 100:1 to 100:200 based on the dry weight of the wax and the lignin, the agricultural composition provides improved UV-B and/or UV-A protection to plants and parts thereof.

According to one embodiment of the present invention the combination of at least one wax and at least one lignin is used as UV-A and/or UV-B protecting agent, wherein the ratio of wax:lignin is from 100:1 to 100:200 based on the dry weight of the wax and the lignin.

Preferably the ratio of wax:lignin is from 100:5 to 100:180, more preferably from 100:10 to 100:150, and most preferably from 100:30 to 100:100 based on the dry weight of the wax and the lignin.

According to another preferred embodiment of the present invention, the at least one wax is carnauba wax and/or the at least one lignin is a water soluble lignin and preferably sulphonated lignin.

According to an exemplified embodiment of the present invention at least one wax and at least one lignin is used as UV-A and/or UV-B protecting agent, wherein the ratio of wax:lignin is from 100:1 to 100:200 based on the dry weight of the wax and the lignin, preferably from 100:5 to 100:180, more preferably from 100:10 to 100:150, and most preferably from 100:30 to 100:100, wherein the at least one wax is carnauba wax and the at least one lignin is sulphonated lignin.

The scope and interest of the invention will be better understood based on the following examples which are intended to illustrate certain embodiments of the present invention and are non-limitative.

### FIGURES

FIG. 1: Schematic of the absorbance measurement with the sample located inside the integrating sphere.

FIG. 2: Schematic of the transmittance measurement with the integrating sphere.

FIG. 3: Absorbance of the agricultural compositions with 0, 0.5, 1.5, 2, 3 and 5 wt.-% lignin.

FIG. 4: Absorbance of the agricultural compositions as a function of lignin concentration at 300 nm and 360 nm.

FIG. 5: Transmittance of an agricultural composition comprising only 5 wt.-% wax, only 5 wt.-% lignin, a combination of 5 wt.-% wax and 5 wt.-% lignin and a combination of 5 wt.-%, 5 wt.-% lignin and 1.5 wt.-% calcium carbonate.

### EXPERIMENTS

### 1. Measurement Methods

In the following, measurement methods implemented in the examples are described.

### Transmittance and Absorbance Measurements

The transmittance and absorbance measurements are carried out with a double beam PerkinElmer Lambda 950 UV/Vis/NIR spectrophotometer equipped with a 150 mm integrating sphere PMT—InGaAs detectors.

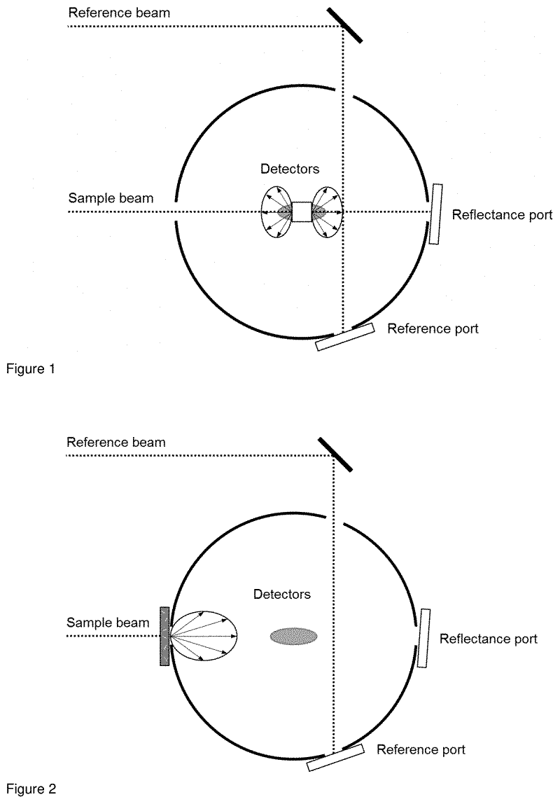

For the absorbance analysis, the tested agricultural compositions are diluted with deionized water in a volume ratio of 1:80. The agricultural compositions are poured in a quartz cuvette with a 1 cm path length and placed with a center mount holder inside the integrating sphere as shown in FIG. 1. This setup allows for simultaneous measurement of both the transmittance (T) and reflectance (R) of the sample, so that the absorbance (A) can be derived as

A=−log(T+R)
in one single measurement.

Deionized water is used as reference measurement. The spectrophotometer is scanned in the range 280 nm-400 nm in steps of 2 nm. Two replicate samples for each diluted agricultural composition are prepared and measured, and the average absorption spectrum is calculated.

For the transmittance analysis, the samples are prepared by spraying the agricultural compositions on a quartz plate (50×50×3 mm). The coated plates are let drying for 1 hour in the dark. The as-prepared plates are placed at the entrance of the integrating sphere as shown in FIG. 2. The transmittance measurements are performed in the range 280 nm-400 nm in steps of 2 nm. Four repetitions are performed on each sample at different sample locations obtained by rotating the sample by 90° around the axis of incident light beam. The average transmittance spectrum of the sample is then calculated. Finally, the average transmittance spectra of the samples are normalized to the average transmittance of the bare quartz plate.

### Particle Size Distribution

The weight determined median particle size d50(wt) was measured by the sedimentation method, which is an analysis of sedimentation behaviour in a gravimetric field. The measurement was made with a Sedigraph™ 5100 of Micromeritics Instrument Corporation, USA. The method and the instrument are known to the skilled person and are commonly used to determine particle size distributions of fillers and pigments. The measurement was carried out in an aqueous solution of 0.1 wt.-% Na4P2O7. The samples were dispersed using a high speed stirrer and supersonicated.

### 2. Materials Used in the Examples

Wax: Carnauba wax No. 1 yellow (CAS: 8015-86-9), available from Sigma Aldrich under the number 243213-250G

Lignin: Sodium sulphonated lignin, available from Domsjö Fabriker under the trade name Domsjö Lignin DS 10

Emulsifier: stearic acid (CAS: 57-11-4) in powder form, available from Sigma Aldrich under the number 54751 and triethanolamine (CAS: 102-71-6) in liquid form, available from Sigma Aldrich under the number T58300-25G

Water: Distilled water

Calcium carbonate: Ground calcium carbonate of marble type having a calcium carbonate content of more than 97.5 wt.-%; The ground calcium carbonate has a particles size of less than 2 μm in an amount of 52 to 62 wt.-% and a medium particle diameter d50 in the range of 1.2 to 2.2 μm

### 3. Tests

The following agricultural compositions were prepared:

In a heated bottom flask (95° C.), 11 g of carnauba wax was added and mixed slowly to melt the solid. 5 g of stearic acid was added to the latter, then kept under mixing to solubilize. Afterwards, 5 g of triethanolamine was furtherly added to the mixture and kept for 15 minutes. 180 g of boiling hot water was added to the mixture and kept for 30 minutes. Finally, different amounts of water-soluble lignin were added to the composition such that the composition comprises 0, 0.5, 1.5, 2, 3 or 5 wt.-% of lignin based on the total weight of the agricultural composition. The ratios of the wax to the lignin in these compositions are therefore 100:0, 100:10, 100:30, 100:40, 100:60, and 100:100.

Optionally, calcium carbonate is added to these compositions under mixing conditions in an amount of 1.5 wt.-%, based on the total weight of the agricultural compositions.

### Absorbance Tests 01

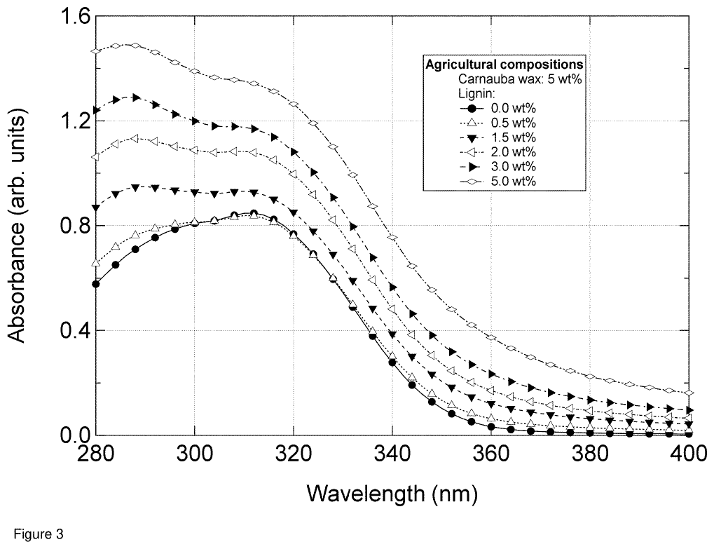

The absorbance of the above prepared agricultural compositions is measured. As can be seen from FIG. 3 the combination of the at least one wax and the at least one lignin in the claimed range leads to an improved absorbance in the UV-A and UV-B range.

### Absorbance Test 02

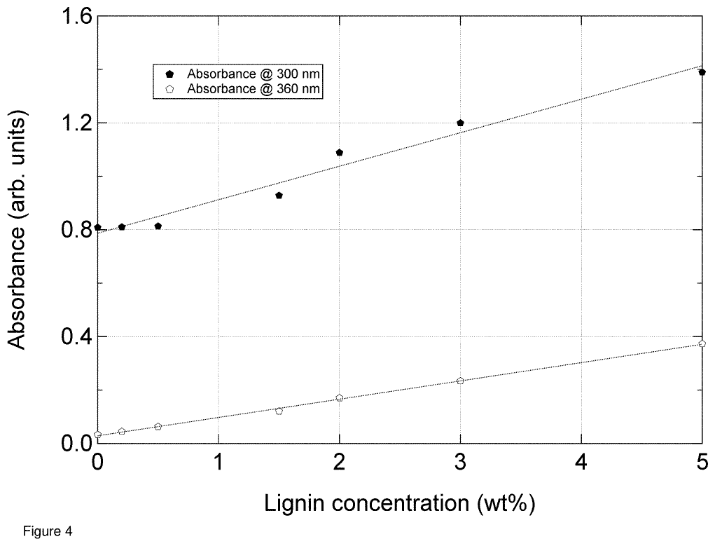

The absorbance of the above prepared agricultural compositions is calculated from FIG. 3 at 300 nm in the UV-B range and at 360 nm in the UV-A range and shown as a function of the lignin concentration. It can be seen from FIG. 4 that the absorbance increases linearly with increasing concentration of lignin. Therefore, the combination of the at least one wax and the at least one lignin leads to an improved absorbance in the UV-A and UV-B range.

### Transmittance Test 01

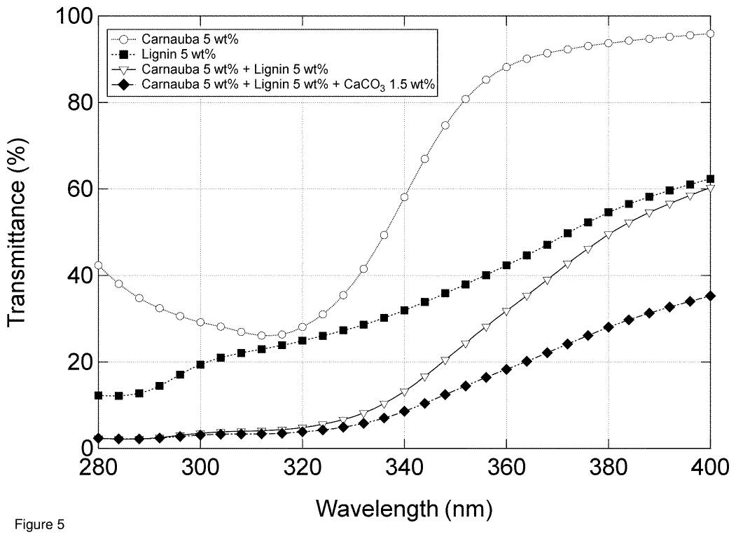

The transmittance of three agricultural compositions comprising only wax (5 wt.-%) or only lignin (5 wt.-%) or a combination of wax and lignin (both 5 wt.-%) is measured. As can be seen from FIG. 5, the lower UV-A and UV-B transmittance is achieved with the combination of both wax and lignin. Therefore, such an agricultural composition containing both wax and lignin could be used as a sunscreen with improved performance compared to an agricultural composition containing only wax or only lignin.

The transmittance of the above prepared agricultural composition comprising a combination of both 5 wt.-% wax and 5 wt.-% lignin and in addition 1.5 wt.-% CaCO3 was also measured. Upon inclusion of CaCO3 in the agricultural composition, the UV-A and UV-B transmittance further decreases.

1. An agricultural composition for providing UV-A and/or UV-B protection to plants and parts thereof, the composition comprising:
at least one wax;
at least one lignin;
at least one emulsifier;
water;
optionally calcium carbonate; and
optionally a solvent;
wherein the ratio of wax:lignin in the composition is from 100:1 to 100:200 based on the dry weight of the wax and the lignin.

2. The agricultural composition according to claim 1, wherein the composition consists of:
at least one wax;
at least one lignin;
at least one emulsifier;
water;
optionally calcium carbonate; and
optionally a solvent.

3. The agricultural composition according to claim 1, wherein the ratio of wax:lignin in the composition is from 100:5 to 100:180, preferably from 100:10 to 100:150, and most preferably from 100:30 to 100:100 based on the dry weight of the wax and the lignin.

4. The agricultural composition according to claim 1, wherein the at least one wax is selected from the group consisting of carnauba wax, bees wax, paraffin wax, shellac wax, candelilla wax, ouricury wax, sugar-cane wax, soy wax, bayberry wax, petroleum waxes, laurel wax, rice bran wax and mixtures thereof and preferably is carnauba wax.

5. The agricultural composition according to claim 1, wherein the at least one lignin is selected from the group consisting of natural lignin, klason lignin, hydrolyzed lignin, milled wood lignin, soda lignin, organosolv lignin, kraft lignin, alkali lignin, sulphonated lignin and mixtures thereof and preferably is sulphonated lignin.

6. The agricultural composition according to claim 1, wherein the at least one emulsifier is selected from the group comprising PEG compounds, PEG-free emulsifier, silicone-based emulsifier, silicones, fatty acids and mixtures thereof.

7. The agricultural composition according to claim 1, wherein the at least one wax and the at least on lignin are each present in the composition in an amount from 0.1 to 45 wt.-% based on the total weight of the agricultural composition, preferably in an amount of 0.5 to 40 wt.-%, even more preferably in an amount of 0.8 to 30 wt.-% and most preferably in an amount of 1 to 20 wt.-% based on the total weight of the agricultural composition.

8. The agricultural composition according to claim 1, wherein the at least one emulsifier is present in the composition in an amount from 0.1 to 30 wt.-% based on the total weight of the agricultural composition, preferably in an amount of 1 to 15 wt.-%, and most preferably in an amount of 2 to 10 wt.-%, based on the total weight of the agricultural composition.

9. The agricultural composition according to claim 1, wherein the agricultural composition comprises calcium carbonate, preferably in an amount from 0.1 to 10 wt.-% based on the total weight of the agricultural composition, more preferably in an amount from 0.3 to 3 wt.-%, even more preferably in an amount from 0.5 to 2 wt.-% and most preferably in an amount from 0.8 to 1.5 wt.-% based on the total weight of the agricultural composition.

10. The agricultural composition according to claim 2, wherein the calcium carbonate is selected from the group consisting of ground calcium carbonate (GCC), preferably marble, limestone, chalk and/or nanoGCC, precipitated calcium carbonate (PCC), preferably vaterite, calcite and/or aragonite, and mixtures thereof and most preferably the calcium carbonate is ground calcium carbonate.

11. The agricultural composition according to claim 1, wherein the solvent is present in the agricultural composition, and preferably the ratio of solvent:lignin in the composition is from 5:1 to 100:1, preferably from 10:1 to 20:1, and most preferably from 12:1 to 16:1 based on the dry weight of the solvent and the lignin.

12. The agricultural composition according to claim 1, wherein the at least one lignin is a water-soluble lignin, preferably sulphonated lignin, and no solvent is present in the agricultural composition.

13. The agricultural composition according to claim 1, wherein the composition is in the liquid form.

14. A method of using an agricultural composition according to claims 1 for UV-A and/or UV-B protection of plants and parts thereof, comprising the step of applying the agricultural composition to plants and parts thereof.

15. The method according to claim 14, wherein the plants and parts thereof are fruits, vegetables, trees, seeds, leaves, wood, nuts, crops, crop plants and flowers.

16. A method of using an agricultural composition as a UV-A and/or UV-B protecting agent, comprising the step of applying the agricultural composition to plants and parts thereof,
wherein the agricultural composition comprises at least one wax and at least one lignin,
and wherein the ratio of wax:lignin is from 100:1 to 100:200 based on the dry weight of the wax and the lignin.

17. The agricultural composition according to claim 2, wherein the ratio of wax:lignin in the composition is from 100:5 to 100:180, preferably from 100:10 to 100:150, and most preferably from 100:30 to 100:100 based on the dry weight of the wax and the lignin.

18. The agricultural composition according to claim 2, wherein the at least one wax and the at least on lignin are each present in the composition in an amount of 1 to 20 wt.-% based on the total weight of the agricultural composition.

19. The agricultural composition according to claim 2, the agricultural composition comprises calcium carbonate in an amount from 0.8 to 1.5 wt.-% based on the total weight of the agricultural composition.

20. The agricultural composition according to claim 2 wherein the at least one lignin is a water-soluble lignin, preferably sulphonated lignin, and no solvent is present in the agricultural composition.
